(19) United States
(12) Patent Application Publication
(10) Pub. No.: US 2024/0352192 A1
(43) Pub. Date: Oct. 24, 2024

(54) HIGH TEMPERATURE COATING (HTC) FOR SEALING APPLICATIONS

(71) Applicant: WOLVERINE ADVANCED MATERIALS, LLC, Dearborn, MI (US)

(72) Inventor: Bryan GRACE, Dearborn, MI (US)

(73) Assignee: WOLVERINE ADVANCED MATERIALS, LLC, Dearborn, MI (US)

(21) Appl. No.: 18/683,793

(22) PCT Filed: Aug. 26, 2022
(86) PCT No.: PCT/US22/41621

§ 371 Date: Feb. 15, 2024

Related U.S. Application Data
(60) Provisional application No. 63/246,913, filed on Sep. 22, 2021.

(51) Int. Cl. C08G 73/10; C08K 3/10; C09D 179/08; C09D 183/04

(52) U.S. Cl. CPC C08G 73/1007; C08K 3/10; C09D 179/08; C09D 183/04; C08G 2150/00

(57) ABSTRACT

A durable high temperature coating (HTC) with temperature resistance and adhesion to substrate after exposure may be used in high temperature seal applications such as turbochargers and exhaust gas recirculation (EGR) valves. In some examples, temperature resistant polymers such as polyimides, silicones, and epoxide silicones may be combined with thermally stable fillers to achieve suitable formulations for enhanced thermal resistance as well as good adhesion to substrates.

### CROSS REFERENCE TO RELATED APPLICATIONS

The present application is a U.S. National Stage filing under 35 U.S.C. § 371 of International Application PCT/US22/41624, filed Aug. 26, 2022, which claims the benefit of U.S. Provisional Patent Application Ser. No. 63/246,913 filed on Sep. 22, 2021. The disclosures of the above applications are hereby incorporated by reference for all purposes.

### BACKGROUND

Unless otherwise indicated herein, the materials described in this section are not prior art to the claims in this application and are not admitted as prior art by inclusion in this section.

A gasket is a seal that is designed to fit between two mating surfaces. The purpose of the gasket is to prevent leakage under static and/or dynamic conditions. In high temperature (and often high pressure) environments such as turbochargers or exhaust gas recirculation (EGR) valves, gaskets may help improve the efficiency and power output of the turbocharger as well as reduce emissions in EGR applications. Coatings that can withstand high temperatures (e.g., up to 600° C.) may have characteristics sought after for seal applications.

### SUMMARY

According to some examples, a high temperature coating (HTC) may include a polyimide resin synthesized from a dianhydride and one or more of a dianiline and a diamine in a range from at least 50 weight % to less than 70 weight %; one or more fillers in a range from at least 25 weight % to less than 45 weight %; and one or more additives in a range from at least 0.5 weight % to less than 5 weight %.

According to other examples, a high temperature coating (HTC) may include a silicone resin in a range from at least 50 weight % to less than 70 weight %; one or more fillers in a range from at least 25 weight % to less than 45 weight %; and one or more additives in a range from at least 0.5 weight % to less than 5 weight %.

According to further examples, a high temperature coating (HTC) may include a resin in a range from at least 50 weight % to less than 70 weight %, the resin selected from a list consisting a polyimide, a polyamide, a methylphenyl silicone, an epoxylated silicone, a methoxylated silicone, a polysulfone, or a combination thereof; a filler in a range from at least 25 weight % to less than 45 weight %, the filler selected from a list consisting titanium dioxide, aluminum dioxide, mica, manganese black ferrite spinel, boron nitride, alumina flake, silica carbide, or a combination thereof; and an additive in a range from at least 0.5 weight % to less than 5 weight %, the additive selected from a list consisting a dispersing agent, a wetting agent, a solvent, an adhesion promoter, or a combination thereof.

According to yet other examples, a method to manufacture a high temperature coating (HTC) may include mixing a dianhydride with one or both of a dianiline and a diamine to synthesize a polyimide; mixing the polyimide with a filler and an additive to synthesize a polymer, where the polyimide is in a range from at least 50 weight % to less than 70 weight %, the filler in a range from at least 25 weight % to less than 45 weight %, and the additive is in a range from at least 0.5 weight % to less than 5 weight % in the mixture; and applying the synthesized polymer to a substrate through roll or coil coating.

According to yet further examples, a method to manufacture a high temperature coating (HTC) may include mixing a silicone resin in a range from at least 50 weight % to less than 70 weight % with one or more fillers in a range from at least 25 weight % to less than 45 weight % and one or more additives in a range from at least 0.5 weight % to less than 5 weight %; and applying the synthesized polymer to a substrate through roll or coil coating, where the HTC is thermally stable up to about 600° C.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example turbocharger, where a high temperature coating (HTC) may be used in sealing;

FIG. 2 illustrates an example system for manufacturing example polyimide based HTC;

FIG. 3 illustrates an example system for manufacturing example silicone based HTC;

FIG. 4 illustrates example results of tape test at various temperatures representing adhesion characteristics of an example HTC;

FIG. 5 illustrates example results of thermal gravimetric analysis (TGA) of an example HTC in inert atmosphere;

FIG. 6A through 6C illustrate example results of thermal stability of different formulations of HTC at various temperatures;

FIG. 7 is a flow chart illustrating a method for preparing an example polyimide based HTC; and

FIG. 8 is a flow chart illustrating a method for preparing an example silicone based HTC, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to durable high temperature coatings (HTCs) with temperature resistance and adhesion to substrate after exposure for high temperature seal applications.

Briefly stated, a durable high temperature coating (HTC) with temperature resistance and adhesion to substrate after exposure may be used in high temperature seal applications such as turbochargers and exhaust gas recirculation (EGR) valves. In some examples, temperature resistant polymers such as polyimides, silicones, and epoxide silicones may be combined with thermally stable fillers to achieve suitable formulations for enhanced thermal resistance as well as good adhesion to substrates.

An HTC according to examples may be applied to a substrate such as stainless steel in a coil or roll coating process. In order to improve the flexibility and solubility of these otherwise brittle systems (Polyimides), high molecular weight polymers (1000 g/mol-4000 g/mol) may be incorporated into the HTC backbone. Examples include thermoset polymers/resins which use functionalized end groups to effectively form crosslink networks; as well as utilizing polymers/resins which can undergo hydrolysis/condensation reactions which can be accelerated at elevated temperatures. A binder/filler ratio in the mixture may be optimized to balance mechanical properties as well as processability. Engine, pump, and other application environments components made from HTC coated materials may help to seal high temperature/corrosive components.

In some implementation examples, the resin amount may vary between 50% and 70% and can include a polyimide, a polyamide, a methylphenyl silicone, an epoxylated silicone, a methoxylated silicone, or a polysulfone. Fillers may vary between 25% and 45% and include titanium dioxide, aluminum dioxide, mica, manganese black ferrite spinel, boron nitride, alumina flake, or silica carbide. Other additives may vary between 0% and 5% which include dispersing agents, wetting agents, solvents, and adhesion promoters.

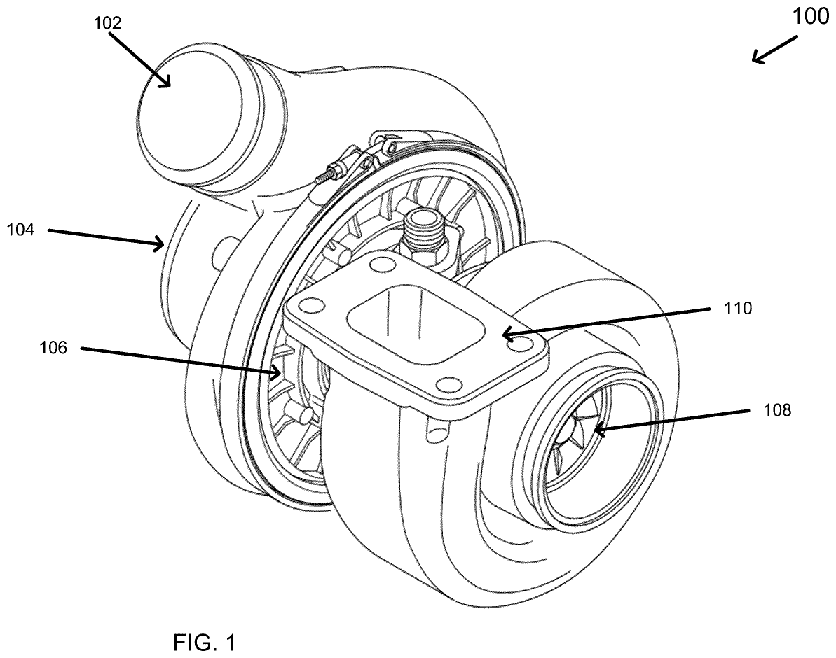

FIG. 1 illustrates an example turbocharger, where a high temperature coating (HTC) may be used in scaling. The example turbocharger 100 includes an air outlet 102, an air inlet 104, an exhaust inlet 110, and an exhaust outlet 108. A compressor wheel 106 is also shown. The compressor wheel is coupled to a turbine wheel inside the exhaust outlet 108.

A turbocharger is a turbine-driven, forced induction device that increases an internal combustion engine's power output by forcing extra compressed air into the combustion chamber. The turbocharger improves a naturally aspirated engine's power output by the compressor forcing more air (and proportionately more fuel) into the combustion chamber than atmospheric pressure.

Turbochargers are used in truck, car, train, aircraft, and construction equipment engines. The turbocharger's compressor draws in ambient air and compresses it before the air enters the intake manifold at increased pressure resulting in a greater mass of air entering the cylinders on each intake stroke. The power needed to spin the centrifugal compressor may be derived from the kinetic energy of the engine's exhaust gases.

A turbocharger may also be used to increase fuel efficiency without increasing power by diverting exhaust waste energy, from the combustion process, and feeding it back into the turbocharger's hot intake side that spins the turbine. As the hot turbine side is being driven by the exhaust energy, the cold intake turbine compresses fresh intake air and drives it into the engine's intake.

The exhaust inlet 110 needs to be sealed to the engine connection to prevent escape of hot gases. That particular portion of the device can reach very high temperatures (e.g., up to 600° C.). For durability, the metal parts of a turbocharger such as the exhaust inlet may be made from stainless steel. Thus, a seal to be used in that portion, needs to be durable at high temperatures. Furthermore, some pump engine applications may subject the seal (along with other parts) to various oils, coolants, and acidic environments.

An HTC for use in seal applications according to examples, possesses superior temperature resistance and adhesion to the substrates after exposure. The adhesion and temperature resistance characteristics also are persistent after immersion in various environments such as those discussed above.

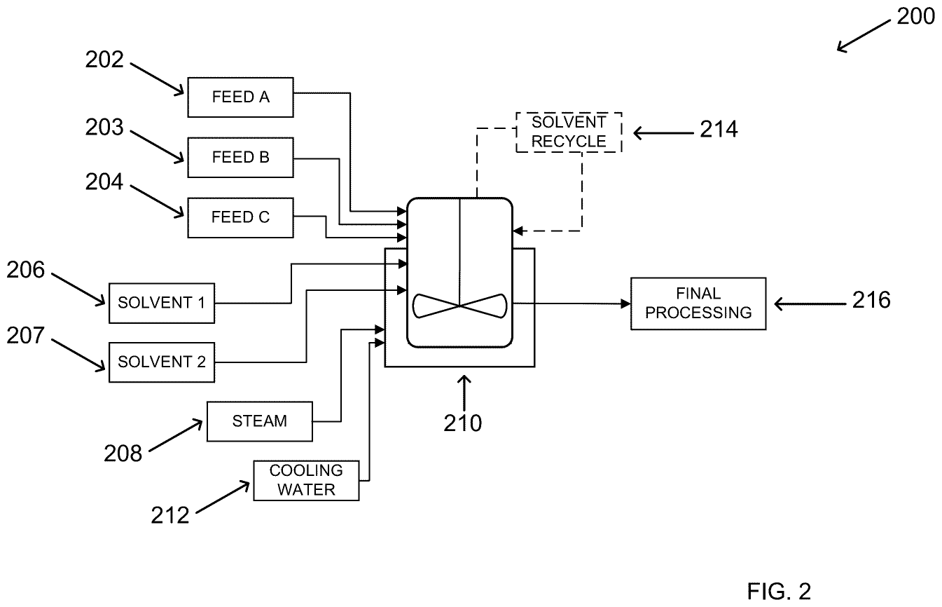

FIG. 2 illustrates an example system for manufacturing example polyimide based HTC, arranged according to aspects of the present disclosure. As shown in diagram 200, a polyimide based HTC manufacturing process may include multiple material feeds 202, 203, 204, solvent feeds 206, 207, a steam feed 208 for temperature adjustment, and a cooling water feed 212, all feeding into a batch reactor 210, where fed materials and solvents are mixed under controlled temperature and pressure. The synthesized compound may be provided to final processing 216, where the HTC may be cured on substrates through roll or coil coating approaches. In some examples, a solvent recycle mechanism 214 may be used to continuously remove the water which is formed during the synthesis process by the use of an azeotropic solvent.

An HTC coating according to examples is intended to improve sealing properties which traditional metal gaskets/coated gaskets cannot. Thus, the HTC has high durability and sustainability against heat. Typical application environments for the HTC may include smooth metallic surfaces such as stainless steel. Thus, enhanced adhesion properties of the HTC allow bonding to such smooth surfaces. Example HTCs are thermally stable at temperatures up to 600° C. (1112° F.) and do not flake off substrate after exposure to extreme temperatures. Example HTCs may also fulfill microsealing requirements and be easy and affordably manufacturable (e.g., transfer, mixing and curing). Furthermore, the synthesized polymers are applicable for roll/coil coating processes.

A polyimide based HTC may include a dianhydride monomer (e.g., BOCA) mixed with a diamine (e.g. ODA and or BAPP) along with an amine-terminated-polydimethyl-siloxane (PDMS) or polyoxyalkyleneamine (POPDA) to increase flexibility, where the molar ratio of the dianhydride to diamine may be 1:1.

The example system in diagram 200 is shown with three material feeds and two solvent feeds. Embodiments are not limited to those configurations. Additional or fewer material feeds and/or solvent feeds may also be used. Various material flow controllers (e.g., pumps, valves), temperature controllers, pressure controllers, and level controllers (inside the reactor) may be employed along with sensors in a remotely controller and automated or semi-automated manufacturing system for HTC synthesis.

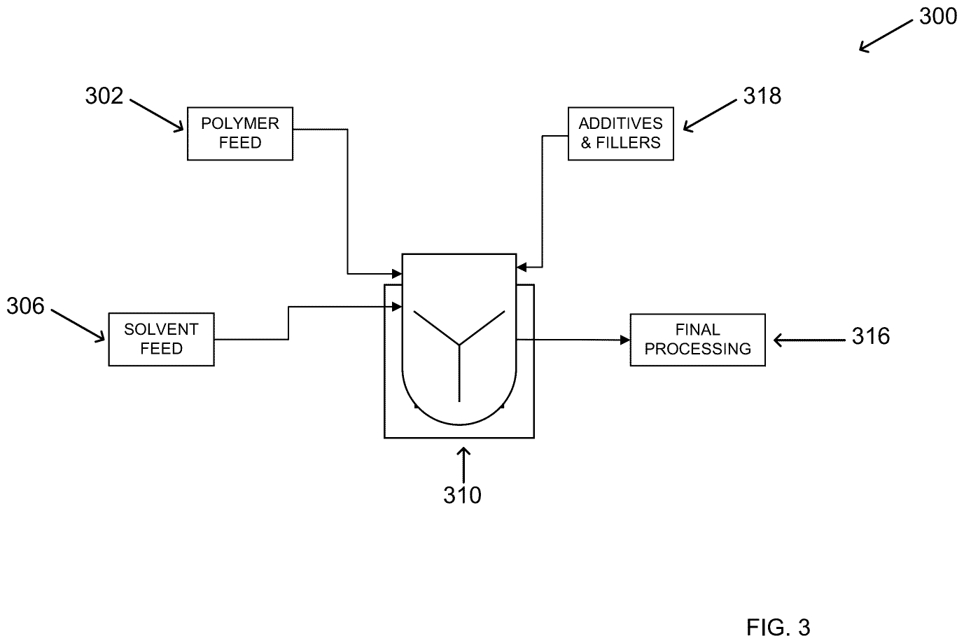

FIG. 3 illustrates an example system for manufacturing example silicone based HTC, arranged according to aspects of the present disclosure. As shown in diagram 300, a silicon based HTC manufacturing process may include a polymer feed 302, a solvent feed 306, and one or more additive and filler feeds 318, all feeding into a mixer 210, where the fed materials and solvents are mixed. The synthesized compound may be provided to final processing 316, where the HTC may be cured on substrates through roll or coil coating approaches.

A silicone based HTC may include a methyl phenyl silicone resin, an epoxy modified silicone resin, and or a novalc epoxy modified silicone resin mixed with a variety of thermally stable fillers, dispersing agents, and other additives such as adhesion promoters. In the mixture, an amount of resin may be varied from 5% to 95%. Similarly, amounts of fillers, dispersing agents, and stabilizers may also be varied from 5% to 95%.

As in FIG. 2, various material flow controllers (e.g., pumps, valves), temperature controllers, pressure controllers, and level controllers (inside the mixer) may be employed along with sensors in a remotely controller and automated or semi-automated manufacturing system for HTC synthesis shown in FIG. 3.

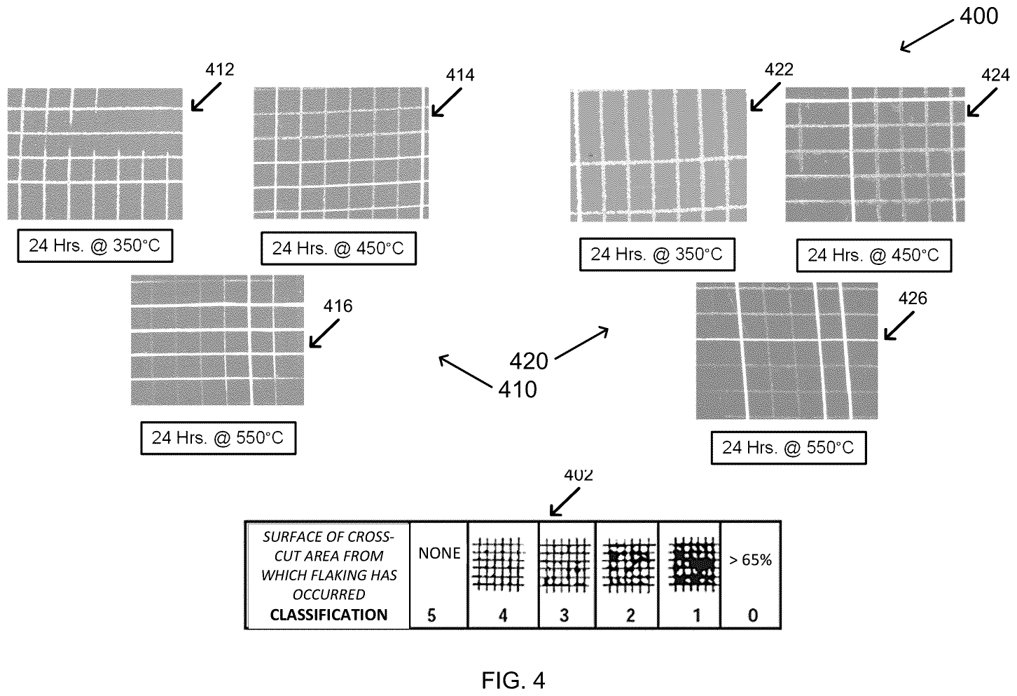

FIG. 4 illustrates example results of tape test at various temperatures representing adhesion characteristics of an example HTC, arranged according to aspects of the present disclosure.

Peel testing is defined as a method for making a quantified assessment of the adhesion of a surface or near-to-surface layer to a substrate. Pressure-sensitive tape may be applied to the investigated area and the amount of material detached from the surface after peeling the tape off is measured. Diagram 400 shows tape test results of two example formulations at three different temperatures. A classification legend 402 is also provided. First set of results 410 are for silicone resin formulation 1, as discussed in more detail below in Example 5. The results illustrate less than substantial flaking after 24 hours at 350° C. (412), 450° C. (414), and 550° C. (416). Similarly, the second set of result 420 are for silicone resin formulation 2, as discussed in more detail in Example 6 below. The second set of results illustrate less than substantial flaking after 24 hours at 350° C. (422), 450° C. (424), and 550° C. (426).

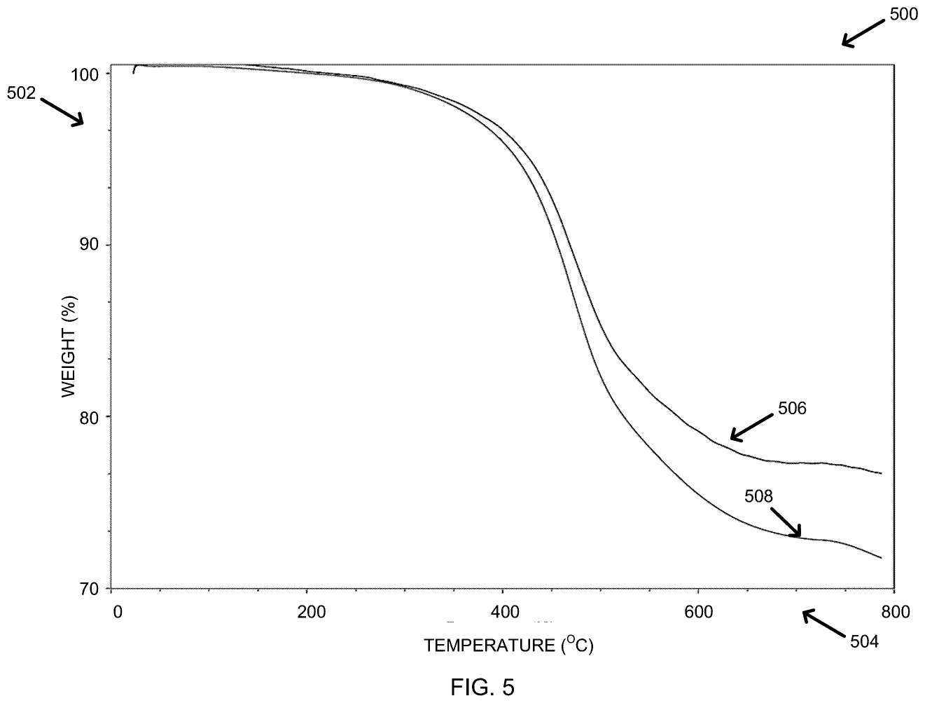

FIG. 5 illustrates example results of thermal gravimetric analysis (TGA) of an example HTC in inert atmosphere, arranged according to aspects of the present disclosure.

Thermal gravimetric analysis (TGA) is a method of thermal analysis in which the mass of a sample is measured over time as the temperature changes. This measurement provides information about physical phenomena, such as phase transitions, absorption, adsorption and desorption; as well as chemical phenomena including chemisorptions, thermal decomposition, and solid-gas reactions (e.g., oxidation or reduction). As shown in diagram 500, the temperature (504) is increased linearly to incur a thermal reaction while weight (502) is monitored. While the thermal reaction may occur under a variety of atmospheres, the test for the illustrated results was performed in an inert atmosphere. The graphs of both formulations (silicone resin formulation 1 and 2) show a relatively steady preservation of weight percentage up to 400° C., followed by a drop from about 100% to a range between 70% and 80%. The graph (506) for formulation 1 shows higher weight % at higher temperature compared to the graph (508) for formulation 2. It should be noted that even at 800° C., both formulations still retain more than 70% of their weight %.

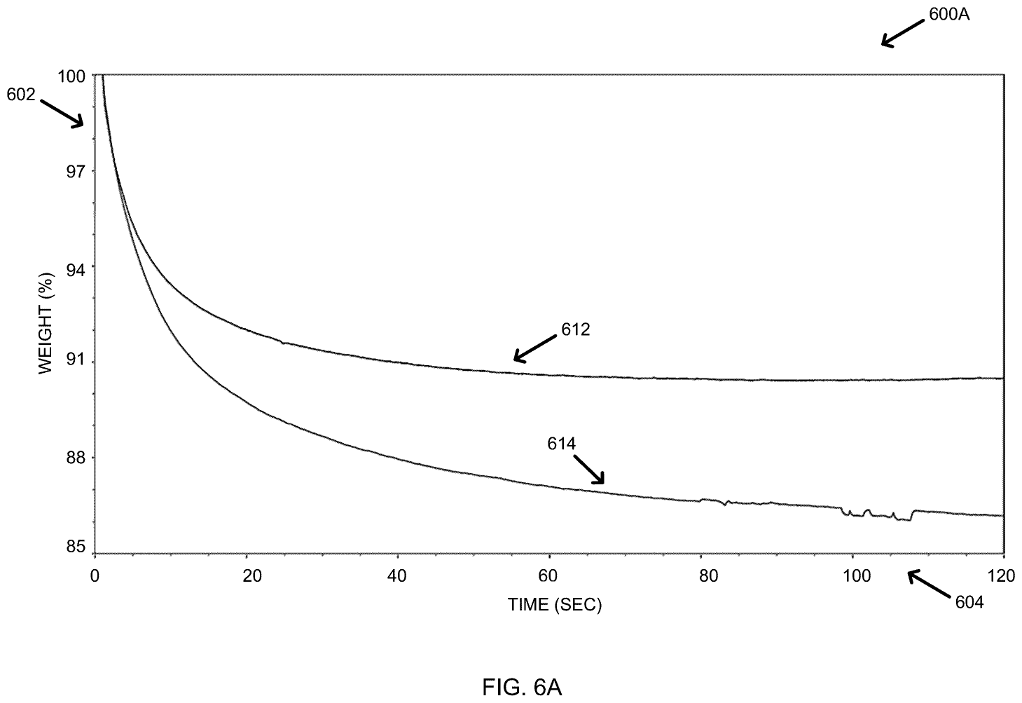

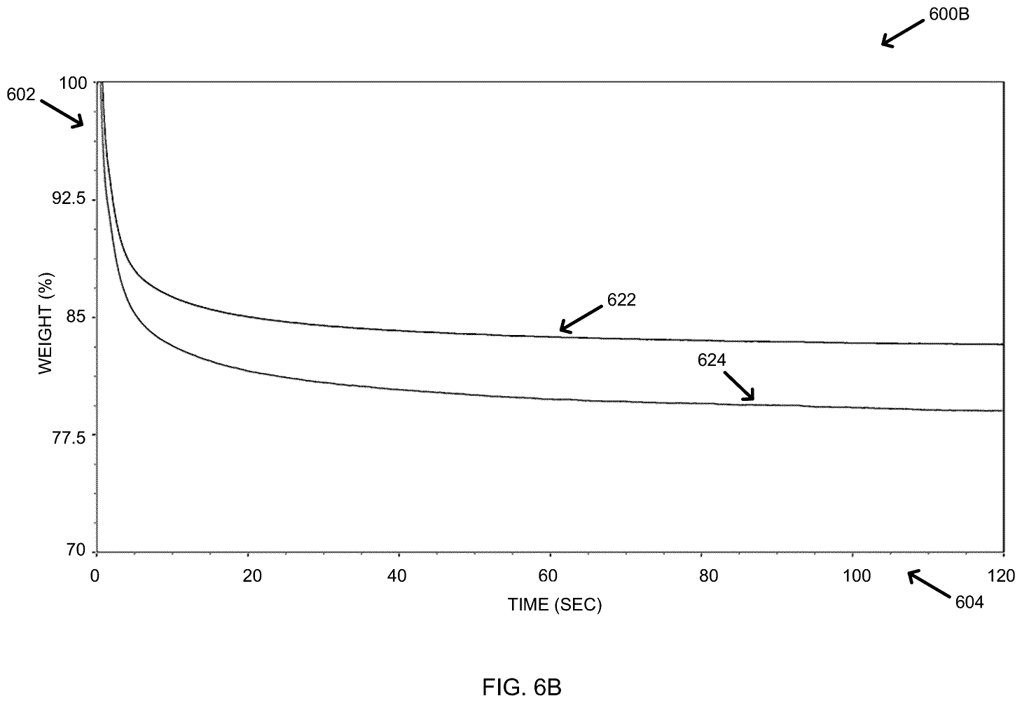

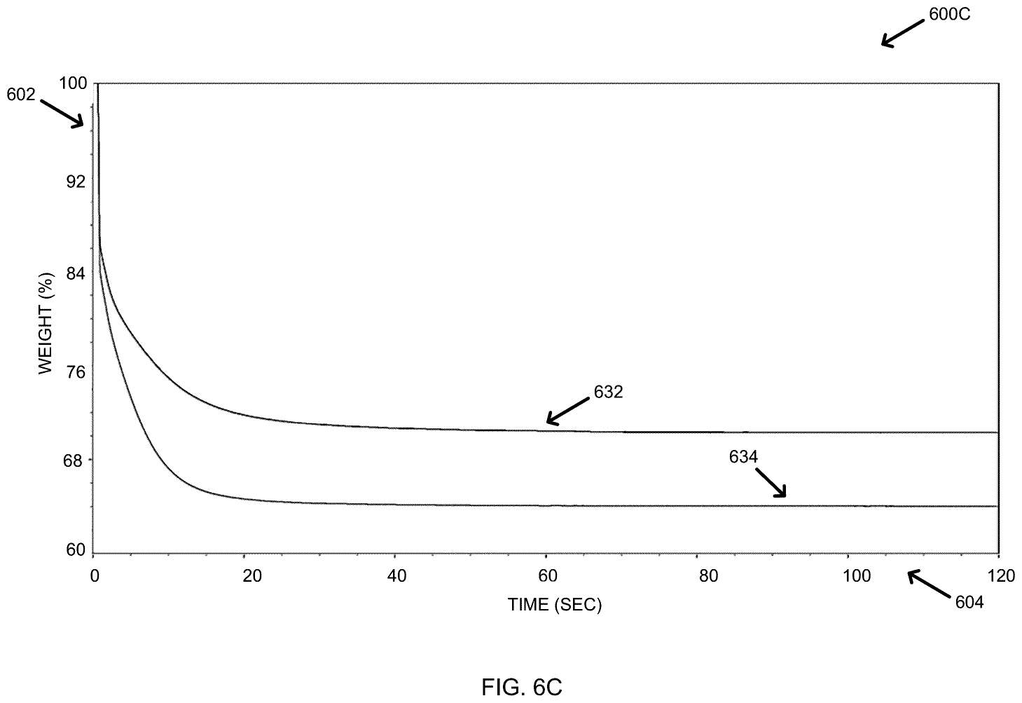

FIG. 6A through 6C illustrate example results of thermal stability of different formulations of HTC at various temperatures, arranged according to aspects of the present disclosure.

Another parameter in TGA tests is time. Diagrams 600A, 600B, and 600C show weight % changes for formulations 1 and 2 at three different constant temperatures over time. All three diagrams have weight % axis 602 and time (seconds) axis 604. In diagram 600A for 350° C., the weight % of the formulation 1 (graph 612) drops from about 100% to approximately 91% and remains steady with passing time, whereas the weight % of formulation 2 (graph 614) drops from about 100% to approximately 87% and remains relatively steady (although there is another drop of about 1%).

In diagram 600B for 400° C., the weight % of the formulation 1 (graph 622) drops from about 100% to approximately 85% and remains steady with passing time, whereas the weight % of formulation 2 (graph 624) drops from about 100% to approximately 81% and remains relatively steady. In diagram 600C for 600° C., the weight % of the formulation 1 (graph 632) drops from about 100% to approximately 72% and remains steady with passing time, whereas the weight % of formulation 2 (graph 634) drops from about 100% to approximately 64% and remains relatively steady. Thus, formulation 1 performs better than formulation 2, but both formulations retain substantial mass even at very high temperatures such as 600° C.

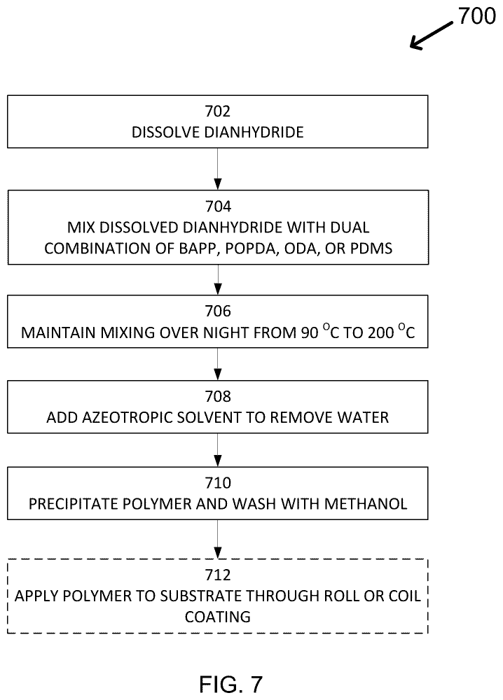

FIG. 7 is a flow chart illustrating a method for preparing an example polyimide based HTC, arranged according to aspects of the present disclosure.

The described method 700, may include block 702, “DISSOLVE DIANHYDRIDE”, block 704 “MIX DIANHYDRIDE WITH DUAL COMBINATION OF BAPP, POPDA, ODA, OR PDMS”, block 706, “MAINTAIN MIXING OVER NIGHT FROM 90° C. TO 200° C.”, block 708, “ADD AZEOTROPIC SOLVENT TO REMOVE WATER”, block 710, “PRECIPITATE POLYMER AND WASH WITH METHANOL”, and optional block 712, “APPLY POLYMER TO SUBSTRATE THROUGH ROLL OR COIL COATING.” At block 702, a duanhydride such as Bicyclo [2.2.2]oct-7ene-2,3,5,6-tetracarboxylic dianhydride (BOCA) may be dissolved with m-creosol. The dissolved resin may then be mixed with 4, 4′-(4, 4′-Isopropylidenediphenyl-1, 1′-diyldioxy) dianiline (BAPP) and polyoxypropylene Diamine (POPDA) at block 704. Alternatively, the dissolved resin may be mixed with 4, 4′-Oxydianiline (ODA) and POPDA. In other examples, the dissolved resin may be mixed with BAPP and polydimethylsiloxane (PDMS). In yet other examples, the dissolved resin may be mixed with ODA and PDMS. The mixture may be slowly heated (e.g., 90° C. to 200° C. for 8 hours or similar). A small amount of an azeotropic solvent such as toluene may be added to the system to remove water formed as a byproduct of the reaction. The polymer may then be precipitated and washed with methanol before being re-dissolved in a polar aprotic solvent. Finally, the polymer may be applied to a substrate through roll or coil coating approaches.

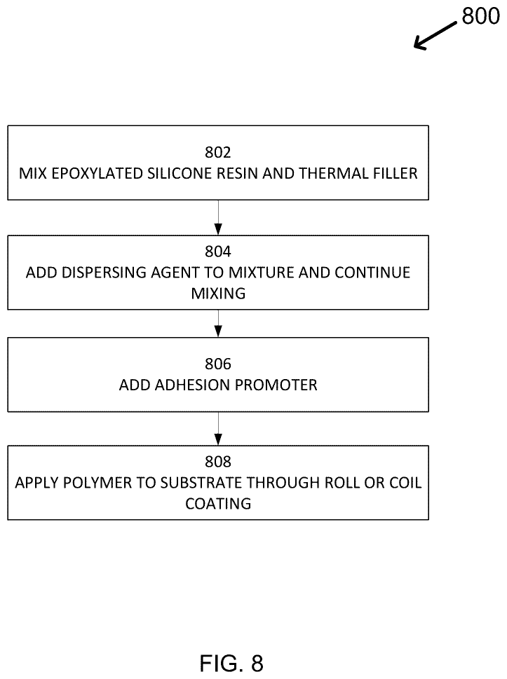

FIG. 8 is a flow chart illustrating a method for preparing an example silicone based HTC, arranged according to aspects of the present disclosure.

The described method 800, may include block 802, “MIX EPOXYLATED SILICONE RESIN AND THERMAL FILLER”, block 804, “ADD DISPERSING AGENT TO MIXTURE AND CONTINUE”, block 806, “ADD ADHESION PROMOTER”, AND block 808, “APPLY POLYMER TO SUBSTRATE THROUGH ROLL OR COIL COATING.” At block 802, An epoxylated silicone resin may be mixed with thermal fillers such as manganese black ferrite spinel and Mica in a high shear dispersion blade mixer, for example. A dispersing agent such as BYK 180 may be added to the mixture and further mixed. Because the adhesion promoter may also act as a crosslinker, it may be added right before the coating process. Finally, the polymer may be applied to a substrate through roll or coil coating approaches.

### EXAMPLES

The following examples are intended as illustrative and non-limiting and represent specific embodiments of the present disclosure. The examples show that a variety disclosed coatings may be synthesized with high durability, temperature resistance, and ease of manufacturing.

### Example 1

### Polyimide Based Formulation 1

3-5 g of Bicyclo [2.2.2]oct-7ene-2,3,5,6-tetracarboxylic dianhydride (BOCA) is placed in a three-neck flask equipped with a mechanical stirrer, nitrogen inlet, dean strak trap, and condenser. 60ml of m-cresol is charged into the flask. Once the BOCA dianhydride dissolved, 4-6 g of 4, 4′-(4, 4′-Isopropylidenediphenyl-1, 1′-diyldioxy) dianiline (BAPP) and 7-10 g of polyoxypropylene Diamine [POPDA] are added and allowed to mix overnight at 90° C. before increasing the temperature to a final imidization temperature of 200° C. for 8 hours. A small amount of an azeotropic solvent such as toluene is added to the system to remove water, which is formed as a byproduct of the reaction. The polymer is subsequently precipitated and washed with methanol before being re-dissolved in a polar aprotic solvent. Following table illustrates ratios (mole fraction) of the components along with various measured characteristics:

TABLE 1
Formulation 1

| | Mole | |
|---|---|---|
| | Fraction | |
| Bicyclo[2.2.2]oct-7-ene-2,3,5,6-tetracarboxylic dianhydride | 1.0 | |
| [BOCA] | | |
| 2,2-Bis[4-(4-aminophenoxy)phenyl]propane [BAPP] | 0.75 | |
| Polyoxypropylene Diamine [POPDA] | 0.25 | |
| Dimethylacetamide [DMAc] | 150 | g |

Properties

| Tensile | 25 ± 1 | |
|---|---|---|
| Elongation | 98 ± 14 | |
| Degradation Temperature T90 | 360° | C. |
| Glass Transition Temperature Tg | 190° | C. |

### Example 2

### Polyimide Based Formulation 2

3-5 g of Bicyclo [2.2.2]oct-7ene-2,3,5,6-tetracarboxylic dianhydride (BOCA) is placed in a three-neck flask equipped with a mechanical stirrer, nitrogen inlet, dean strak trap, and condenser. 60 ml of m-cresol is charged into the flask. Once the BOCA dianhydride dissolved, 2-4 g of 4, 4′-Oxydianiline (ODA) and 7-10 g of polyoxypropylene Diamine [POPDA] are added and allowed to mix overnight at 90° C. before increasing the temperature to a final imidization temperature of 200° C. for 8 hours. A small amount of an azeotropic solvent such as toluene is added to the system to remove water which is formed as a byproduct of the reaction. The polymer is subsequently precipitated and washed with methanol before being re-dissolved in a polar aprotic solvent. Following table illustrates ratios (mole fraction) of the components along with various measured characteristics:

TABLE 2
Formulation 2

| | Mole | |
|---|---|---|
| | Fraction | |
| Bicyclo[2.2.2]oct-7-ene-2,3,5,6-tetracarboxylic dianhydride | 1.0 | |
| [BOCA] | | |
| 4,4′-Oxydianiline (ODA) | 0.75 | |
| Polyoxypropylene Diamine [POPDA] | 0.25 | |
| Dimethylacetamide [DMAc] | 150 | g |

Properties

| Tensile | 17 ± 3 | |
|---|---|---|
| Elongation | 115 ± 35 | |
| Degradation Temperature T90 | 371° | C. |
| Glass Transition Temperature Tg | 182° | C. |

### Example 3

### Polyimide Based Formulation 3

3-5 g of Bicyclo [2.2.2]oct-7ene-2,3,5,6-tetracarboxylic dianhydride (BOCA) is placed in a three-neck flask equipped with a mechanical stirrer, nitrogen inlet, dean strak trap, and condenser. 60 ml of m-cresol is charged into the flask. Once the BOCA dianhydride dissolved,4-6 g of 4, 4′-(4, 4′-Isopropylidenediphenyl-1, 1′-diyldioxy) dianiline (BAPP) and 15-20 g of polydimethylsiloxane [PDMS] are added and allowed to mix overnight at 90° C. before increasing the temperature to a final imidization temperature of 200° C. for 8 hours. A small amount of an azeotropic solvent such as toluene is added to the system to remove water which is formed as a byproduct of the reaction. The polymer is subsequently precipitated and washed with methanol before being re-dissolved in a polar aprotic solvent. Following table illustrates ratios (mole fraction) of the components along with various measured characteristics:

TABLE 3
Formulation 3

| | Mole | |
|---|---|---|
| | Fraction | |
| Bicyclo[2.2.2]oct-7-ene-2,3,5,6-tetracarboxylic | 1.0 | |
| dianhydride [BOCA] | | |
| 2,2-Bis[4-(4-aminophenoxy)phenyl]propane [BAPP] | 0.75 | |
| Polydimethylsiloxane (PDMS) Mw 1400-4000 g/mol | 0.25 | |
| Dimethylacetamide [DMAc] | 150 | g |

Properties

| Tensile | N/a [Material | |
|---|---|---|
| | too brittle | |
| Elongation | N/a [Material | |
| | too brittle | |
| Degradation Temperature T90 | 439° | C. |
| Glass Transition Temperature Tg | 291° | C. |

### Example 4

### Polyimide Based Formulation 4

3 -5g of Bicyclo [2.2.2]oct-7ene-2,3,5,6-tetracarboxylic dianhydride (BOCA) is placed in a three-neck flask equipped with a mechanical stirrer, nitrogen inlet, dean strak trap, and condenser. 60 ml of m-cresol is charged into the flask. Once the BOCA dianhydride dissolved, 2-4 g of 4, 4′-Oxydianiline (ODA) and 15-20 g of polydimethylsiloxane [PDMS] are added and allowed to mix overnight at 90° C. before increasing the temperature to a final imidization temperature of 200° C. for 8 hours. A small amount of an azeotropic solvent such as toluene is added to the system to remove water which is formed as a byproduct of the reaction. The polymer is subsequently precipitated and washed with methanol before being re-dissolved in a polar aprotic solvent. Following table illustrates ratios (mole fraction) of the components along with various measured characteristics:

TABLE 4
Formulation 4

| | Mole | |
|---|---|---|
| | Fraction | |
| Bicyclo[2.2.2]oct-7-ene-2,3,5,6-tetracarboxylic | 1.0 | |
| dianhydride [BOCA] | | |
| 4,4′-Oxydianiline (ODA) | 0.75 | |
| Polydimethylsiloxane (PDMS) Mw 1400-4000 g/mol | 0.25 | |
| Dimethylacetamide [DMAc] | 150 | g |

Properties

| Tensile | N/a [Material | |
|---|---|---|
| | too brittle | |
| Elongation | N/a [Material | |
| | too brittle | |
| Degradation Temperature T90 | 432° | C. |
| Glass Transition Temperature Tg | 310° | C. |

### Example 5

### Silicone Based Formulation 1

Using a high shear dispersion blade, Silkopon EC (Epoxylated Silicone Resin-52.7%), manganese black ferrite spinel (26.0%), and Mica (17.3%) are mixed for 30-60 minutes. Once thoroughly mixed a dispersing agent such as BYK 180 (1.3%) is added and mixed for an additional 15-30 minutes. Since the adhesion promoter (2.7%) used also acts as a crosslinker, it is added right before the coating process. Coatings formulated exhibit adequate fluid resistance and superior temperature resistance for high temperature sealing applications. Curing conditions are selected between 400-500° F. for 10-30 minutes.

### Example 6

### Silicone Based Formulation 2

Using a high shear dispersion blade, Silkopon EC (Epoxylated Silicone Resin-60.5%) and manganese black ferrite spinel (35.41%) are mixed for 30-60 minutes. Once thoroughly mixed a dispersing agent such as BYK 180 (0.883%) is added and mixed for an additional 15-30 minutes. Since the adhesion promoter (3.2%) used also acts as a crosslinker, it is added right before the coating process. Coatings formulated exhibit adequate fluid resistance and superior temperature resistance for high temperature sealing applications. Curing conditions are selected between 400-500° F. for 10-30 minutes.

According to some examples, a high temperature coating (HTC) may include a polyimide resin synthesized from a dianhydride and one or more of a dianiline and a diamine in a range from at least 50 weight % to less than 70 weight %; one or more fillers in a range from at least 25 weight % to less than 45 weight %; and one or more additives in a range from at least 0.5 weight % to less than 5 weight %.

According to other examples, the dianhydride may include bicyclo [2.2.2]oct-7ene-2,3,5,6-tetracarboxylic dianhydride “BOCA”, the diamine may include polyoxypropylene diamine “POPDA”, and the dianiline may include one of 4, 4′-(4, 4′-Isopropylidenediphenyl-1, 1′-diyldioxy) dianiline “BAPP” and oxydianiline “ODA”. The one or more fillers may include titanium dioxide, aluminum dioxide, mica, manganese black ferrite spinel, boron nitride, alumina flake, silica carbide, or a combination thereof. The one or more additives may include a dispersing agent, a wetting agent, a solvent, an adhesion promoter, or a combination thereof. The polyimide resin, the one or more fillers, and the one or more additives may be synthesized under a starting temperature of about 90° C. to an imidization temperature of about 200° C. The HTC may be precipitated and washed with methanol following synthesis and prior to being re-dissolved in a polar aprotic solvent. The HTC may be applied to a substrate through roll or coil coating. The substrate may be stainless steel. The HTC may be thermally stable up to about 600° C.

According to further examples, a high temperature coating (HTC) may include a silicone resin in a range from at least 50 weight % to less than 70 weight %; one or more fillers in a range from at least 25 weight % to less than 45 weight %; and one or more additives in a range from at least 0.5 weight % to less than 5 weight %.

According to some examples, the silicone resin may include one or more of a methylphenyl silicone, an epoxylated silicone, or a methoxylated silicone. The one or more fillers may include titanium dioxide, aluminum dioxide, mica, manganese black ferrite spinel, boron nitride, alumina flake, silica carbide, or a combination thereof. The one or more additives may include a dispersing agent, a wetting agent, a solvent, an adhesion promoter, or a combination thereof. The silicone resin, the one or more fillers, and the one or more additives may be cured in a temperature range from about 200° C. to about 260° C. The HTC may be applied to a substrate through roll or coil coating. The substrate may be stainless steel. The HTC may be thermally stable up to about 600° C.

According to other examples, a high temperature coating (HTC) may include a resin in a range from at least 50 weight % to less than 70 weight %, the resin selected from a list consisting a polyimide, a polyamide, a methylphenyl silicone, an epoxylated silicone, a methoxylated silicone, a polysulfone, or a combination thereof; a filler in a range from at least 25 weight % to less than 45 weight %, the filler selected from a list consisting titanium dioxide, aluminum dioxide, mica, manganese black ferrite spinel, boron nitride, alumina flake, silica carbide, or a combination thereof; and an additive in a range from at least 0.5 weight % to less than 5 weight %, the additive selected from a list consisting a dispersing agent, a wetting agent, a solvent, an adhesion promoter, or a combination thereof.

According to further examples, a binder to filler ratio in the HTC may be selected to balance one or more mechanical properties of the HTC and a processability. The HTC may be applied to a substrate through roll or coil coating. The substrate may be stainless steel. The HTC applied stainless steel may be used to seal two components of a turbocharger or an exhaust gas recirculation (EGR) valve.

According to yet other examples, a method to manufacture a high temperature coating (HTC) may include mixing a dianhydride with one or both of a dianiline and a diamine to synthesize a polyimide; mixing the polyimide with a filler and an additive to synthesize a polymer, where the polyimide is in a range from at least 50 weight % to less than 70 weight %, the filler in a range from at least 25 weight % to less than 45 weight %, and the additive is in a range from at least 0.5 weight % to less than 5 weight % in the mixture; and applying the synthesized polymer to a substrate through roll or coil coating.

According to some examples, mixing the dianhydride with the one or both of the dianiline and the diamine may include mixing bicyclo [2.2.2]oct-7ene-2,3,5,6-tetracarboxylic dianhydride “BOCA” with polyoxypropylene diamine “POPDA” and one of 4, 4′-(4, 4′-Isopropylidenediphenyl-1, 1′-diyldioxy) dianiline “BAPP” and oxydianiline “ODA”. The method may further include dissolving the dianhydride with m-creosol prior to mixing with the dianiline and/or diamine. Mixing the polyimide with the filler may include mixing the polyimide with titanium dioxide, aluminum dioxide, mica, manganese black ferrite spinel, boron nitride, alumina flake, silica carbide, or a combination thereof. Mixing the polyimide with the additive may include mixing the polyimide with a dispersing agent, a wetting agent, a solvent, an adhesion promoter, or a combination thereof. The method may also include synthesizing the polymer under a starting temperature of about 90° C. to an imidization temperature of about 200° C. The method may further include precipitating and washing the synthesized polymer with methanol; and re-dissolving in a polar aprotic solvent. The substrate may be stainless steel. The HTC may be thermally stable up to about 600° C.

According to yet further examples, a method to manufacture a high temperature coating (HTC) may include mixing a silicone resin in a range from at least 50 weight % to less than 70 weight % with one or more fillers in a range from at least 25 weight % to less than 45 weight % and one or more additives in a range from at least 0.5 weight % to less than 5 weight %; and applying the synthesized polymer to a substrate through roll or coil coating, where the HTC is thermally stable up to about 600° C.

According to other examples, the silicone resin may include one or more of a methylphenyl silicone, an epoxylated silicone, or a methoxylated silicone. Mixing the silicone resin with the filler may include mixing the silicone resin with titanium dioxide, aluminum dioxide, mica, manganese black ferrite spinel, boron nitride, alumina flake, silica carbide, or a combination thereof. Mixing the silicone resin with the additive may include mixing the silicone resin with a dispersing agent, a wetting agent, a solvent, an adhesion promoter, or a combination thereof. The method may also include curing the mixture in a temperature range from about 200° C. to about 260° C. The substrate may be stainless steel.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

The herein described subject matter sometimes illustrates different components contained within, or connected with, different other components. Such depicted architectures are merely examples, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1.-37. (canceled)

38. A high temperature coating (HTC), the HTC comprising:
a polyimide resin synthesized from a dianhydride and one or more of a dianiline and a diamine in a range from at least 50 weight % to less than 70 weight %, wherein the dianhydride comprises bicyclo [2.2.2]oct-7ene-2,3,5,6-tetracarboxylic dianhydride “BOCA”, the diamine comprises polyoxypropylene diamine “POPDA”, and the dianiline comprises one of 4, 4′-(4, 4′-Isopropylidenediphenyl-1, 1′-diyldioxy) dianiline “BAPP” and oxydianiline “ODA”;
one or more fillers in a range from at least 25 weight % to less than 45 weight %; and
one or more additives in a range from at least 0.5 weight % to less than 5 weight %.

39. The HTC of claim 38, wherein the one or more fillers comprise titanium dioxide, aluminum dioxide, mica, manganese black ferrite spinel, boron nitride, alumina flake, silica carbide, or a combination thereof.

40. The HTC of claim 38, wherein the one or more additives comprise a dispersing agent, a wetting agent, a solvent, an adhesion promoter, or a combination thereof.

41. The HTC of claim 38, wherein the polyimide resin, the one or more fillers, and the one or more additives are synthesized under a starting temperature of about 90° C. to an imidization temperature of about 200° C.

42. The HTC of claim 38, wherein the HTC is applied to a substrate through roll or coil coating.

43. The HTC of claim 42, wherein the substrate is stainless steel.

44. The HTC of claim 38, wherein the HTC is thermally stable up to about 600° C.

45. A high temperature coating (HTC), the HTC comprising:
a silicone resin in a range from at least 50 weight % to less than 70 weight %, wherein the silicone resin comprises one or more of a methylphenyl silicone, an epoxylated silicone, or a methoxylated silicone;
one or more fillers in a range from at least 25 weight % to less than 45 weight %; and
one or more additives in a range from at least 0.5 weight % to less than 5 weight %.

46. The HTC of claim 45, wherein the one or more fillers comprise titanium dioxide, aluminum dioxide, mica, manganese black ferrite spinel, boron nitride, alumina flake, silica carbide, or a combination thereof.

47. The HTC of claim 45, wherein the one or more additives comprise a dispersing agent, a wetting agent, a solvent, an adhesion promoter, or a combination thereof.

48. The HTC of claim 45, wherein the silicone resin, the one or more fillers, and the one or more additives are cured in a temperature range from about 200° C. to about 260° C.

49. The HTC of claim 45, wherein the HTC is applied to a substrate through roll or coil coating.

50. The HTC of claim 49, wherein the substrate is stainless steel.

51. The HTC of claim 45, wherein the HTC is thermally stable up to about 600° C.

52. A high temperature coating (HTC), the HTC comprising:
a resin in a range from at least 50 weight % to less than 70 weight %, the resin selected from a list consisting a polyimide, a polyamide, a methylphenyl silicone, an epoxylated silicone, a methoxylated silicone, a polysulfone, or a combination thereof;
a filler in a range from at least 25 weight % to less than 45 weight %, the filler selected from a list consisting titanium dioxide, aluminum dioxide, mica, manganese black ferrite spinel, boron nitride, alumina flake, silica carbide, or a combination thereof; and
an additive in a range from at least 0.5 weight % to less than 5 weight %, the additive selected from a list consisting a dispersing agent, a wetting agent, a solvent, an adhesion promoter, or a combination thereof.

53. The HTC of claim 52, wherein a binder to filler ratio in the HTC is selected to balance one or more mechanical properties of the HTC and a processability.

54. The HTC of claim 52, wherein the HTC is applied to a substrate through roll or coil coating.

55. The HTC of claim 54, wherein the substrate is stainless steel.

56. The HTC of claim 52, wherein the HTC applied stainless steel is used to seal two components of a turbocharger or an exhaust gas recirculation (EGR) valve.
